(19) United States
(12) Patent Application Publication
(10) Pub. No.: US 2003/0074928 A1
(43) Pub. Date: Apr. 24, 2003

(54) Draw tower for optical fiber producing systems

(76) Inventors: Youn-Ho Kuk, Susung Gu (KR); Tae-Youn Ko, Seo-Gu (KR)

Correspondence Address: Paul J. Ferrell, Esq., DILWORTH & BARRESE, LLP, 333 Earle Ovington Blvd., Uniondale, NY, 11553, US

(21) Appl. No.: 10/072,726

(22) Filed: Feb. 6, 2002

(30) Foreign Application Priority Data
Oct. 22, 2001 (KR) 2001-0064982

(51) Int. Cl. C03B 37/025

(52) U.S. Cl. 65/537

(57) ABSTRACT

Disclosed herein is a draw tower for optical fiber producing systems. The draw tower supports a preform feed unit, a furnace, a spinning nozzle, a diameter gauge, and a coating unit thereon. The draw tower includes a plurality of vertically assembled frames. Each of the frames consists of a hollow column vertically erected at each corner to form a square structure, a plurality of horizontal beams horizontally extending between the upper ends and the lower ends of the columns, and a cantilever beam diagonally connected between the columns. The cantilever beam of at least one upper frame has a cross-sectional area smaller than that of a conventional cantilever beam, thus reducing weight of the upper part of the draw tower. The hollow columns of at least one lower frame each have the same cross-sectional area as that of a conventional hollow column while having thicker walls than a conventional column, thus reinforcing the lower part of the draw tower in addition to preventing vibration of the draw tower. A support is provided at the lowest-most frame of the draw tower for additionally supporting the lower part of the draw tower.

### PRIORITY

This application claims priority to an application entitled “Draw Tower for Optical Fiber Producing Systems” filed in the Korean Industrial Patent Office on Oct. 22, 2001 and assigned Serial No. 2001-64982, the contents of which are hereby incorporated by reference.

### BACKGROUND OF THE INVENTION

1. Field of the Invention

The present invention relates generally to a draw tower for optical fiber producing systems, and more particularly, to a draw tower having increased durability and resistance to vibrations, when used in a dual-type system for producing optical fibers.

2. Description of the Prior Art

As well known to those skilled in the art, an optical fiber is a wave guide having the same shape as that of a fiber and functions to transmit light. Such an optical fiber is typically made of synthetic resins and glasses. Above all, glass having superior transparency is mainly used as a material of optical fibers.

Such an optical fiber 30, as shown in FIG. 2, has a shape of a concentric circle when taken in a cross-sectional view, that is, it consists of a core section 31 positioned along the central axis of the optical fiber 30, a cladding section 32 surrounding the core 31, and an outer coating layer 33 made of appropriate materials, such as synthetic resins for protecting the optical fiber 30 from external conditions, such as impact. The diameter of the optical fiber is typically one hundred˜several hundred micrometers. Since the refractivity of the core section 31 is higher than that of the cladding section 32, the light is concentrated in the core section 31 without being dispersed to the outside, and the light progresses along the length of the fiber.

Such an optical fiber is advantageous in that there is no interference by electromagnetic waves, and is not subject to the danger of wiretapping. Furthermore, the optical fiber has another advantage in that it is small in size, in addition to its light weight, and has superior flexibility. The optical fiber has still another advantage in that many communication circuits can be served per one optical fiber. Therefore, recently, optical fibers have been widely used for communication, in addition to image transmission and detection.

There are several methods to produce such optical fibers, including a method using a melting pot, an external deposition method, an internal deposition method, an axial deposition method, a spinning method, etc. Of these, the spinning method has been the most widely used. According to the spinning method, a preform consisting of a rod of about 1 cm in diameter and having the same structure and material as the optical fiber, is melted by intense heat and then drawn to a predetermined length, thus obtaining a desired optical fiber.

A conventional system 35 for producing optical fibers by the spinning method is shown in FIG. 1, and will be described hereinafter.

System 35 includes a draw tower 36, a preform feed unit 37, a furnace 38 and a spinning nozzle 39. The draw tower 36 is vertically set on a support surface to have a predetermined height from the support surface. The preform feed unit 37 is installed on the draw tower 36 for feeding a preform to the draw tower 36. The furnace 38 melts the preform fed from the preform feed unit 37. The spinning nozzle 39 discharges the molten preform fed from the furnace 38 to form an optical fiber 30 having a fine diameter.

A diameter gauge 40 is installed below the spinning nozzle 39 and measures the diameter of the optical fiber 30 discharged from the nozzle 39. The optical fiber 30 passes through the draw tower 36 positioned under the diameter gauge 40 while being cooled. A coating unit 41 is installed at the lower portion of the draw tower 36 for allowing the optical fiber 30 to be easily wound around a winding roller 45, in addition to preventing degradation and abrasion of the optical fiber 30.

The process of producing the optical fiber 30 by means of the system 35 is as follows. First, the preform fed to the furnace 38 is melted, and then discharged from the spinning nozzle 39 while being drawn to obtain an optical fiber having a desired fine diameter. While the drawn optical fiber passes through the draw tower 36, it is cooled. Thereafter, the optical fiber passes through the coating unit 41, which coats the surface of the optical fiber with a coating material. Finally, the optical fiber is wound around the winding roller 45.

Since such a system produces optical fibers by the spinning method, the system must have a considerable height, that is, typically a height of 15-25 m from the support surface. Thus, the system has a problem that it must have sufficient strength and stability to be able to resist vibrations and bending during production of optical fibers, to avoid damage to the resultant fibers.

This conventional tower system for producing optical fibers has a single-type structure, and as such the load of the upper part of the draw tower is not excessive, thus having sufficient durability. However, when it is desired to increase production and produce optical fibers by a system modified to be a dual-type structure without changing the size of a framework, the load per unit area is undesirably increased. Thus, dual-type systems have a problem in that they must support an increased load.

When the strength of the dual-type system is insufficient, the optical fibers being formed are undesirably vibrated due to the vibration of the system during production of the optical fiber, making it impossible to produce optical fibers having an excellent quality. Due to such vibration, necessary properties which the optical fiber must have are not ensured.

### SUMMARY OF THE INVENTION

Accordingly, the present invention has been made keeping in mind the above problems occurring in the prior art, and an object of the present invention is to provide a draw tower for optical fiber producing systems, which is improved to maintain sufficient strength, and which reduces the vibration frequency thereof. Thus, the draw tower of the present invention is constructed having desired stability, without changing the cross-sectional area of the draw tower when using a dual-type system for producing optical fibers.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic view showing a system for producing optical fibers;

FIG. 2 is a cross-sectional view of a typical optical fiber;

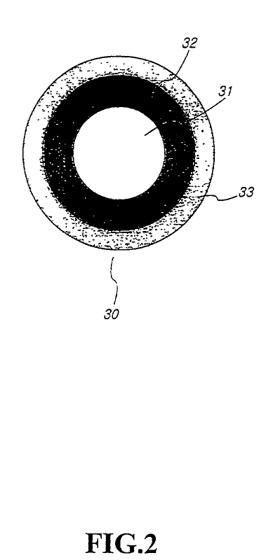

FIG. 3 is a front view of a draw tower for optical fiber producing systems according to the present invention;

FIG. 4 is a cross-sectional view of a cantilever beam of an upper frame of the draw tower according to this invention;

FIG. 5 is a cross-sectional view of a hollow column of a lower frame of the draw tower according to this invention;

FIG. 6 is a front view showing a support of a lowest frame of the draw tower according to this invention; and

FIG. 7 is a top plan view of the support of FIG. 6.

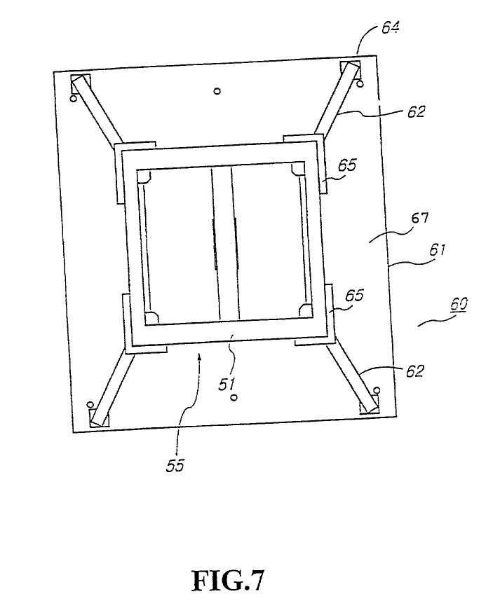

### DETAILED DESCRIPTION OF THE INVENTION

Reference now should be made to the drawings, in which the same reference numerals are used throughout the different drawings to designate the same or similar components.

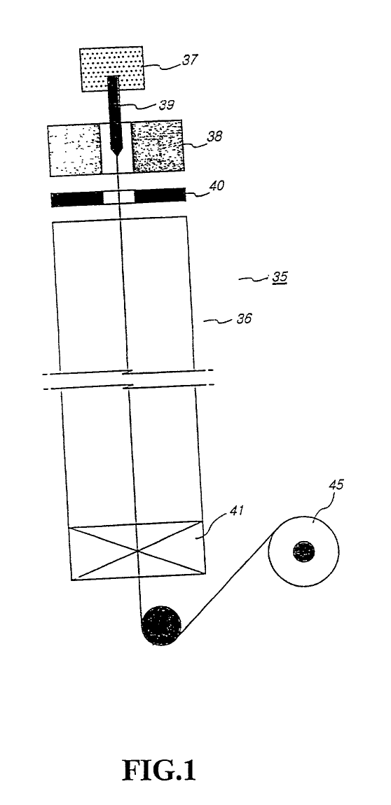

Referring to the drawings, and in particular FIG. 1, a typical system 35 for producing optical fibers includes a draw tower 36, a preform feed unit 37, a furnace 38 and a spinning nozzle 39. The draw tower 36 is set on a support surface to have a predetermined height from the support surface. The preform feed unit 37 is installed on the draw tower 36 for feeding a preform to the draw tower 36. The furnace 38 melts the preform fed from the preform feed unit 37. The spinning nozzle 39 discharges the molten preform fed from the furnace 38 to form an optical fiber 30 having a fine diameter.

A diameter gauge 40 is installed below the spinning nozzle 39 and measures the diameter of the optical fiber 30 discharged from the nozzle 39 to maintain a uniform diameter along the length of the optical fiber 30. A coating unit 41 is installed at a lower portion of the draw tower 36 for applying a coating to the optical fiber, thus allowing the cooled optical fiber 30 passing through the draw tower 36 to be easily wound around a winding roller 45, in addition to preventing degradation and abrasion of the optical fiber 30.

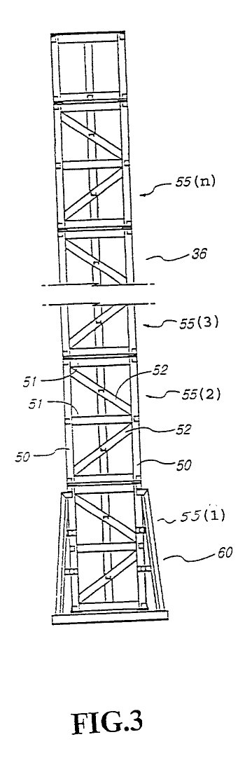

Referring now to FIG. 3, the draw tower 36 of the present invention includes a plurality of vertically assembled frames 55 positioned one on top of the other. Each frame 55 consists of a plurality of columns 50, horizontal beams 51, and cantilever beams 52. The columns 50 and beams 51, 52 are hollow. The columns 50 are each vertically set up at each corner to form a square structure. The horizontal beams 51 horizontally extend between the upper ends and the lower ends of the columns 50. The cantilever beams 52 are diagonally connected to the columns 50.

According to the present invention, the cantilever beams 52 of the upper frames 55(n) are improved in their structure to reduce the weight of the upper part of the draw tower 36. Furthermore, for reinforcing the lower part of the draw tower 36 in addition to preventing vibration of the draw tower 36, the hollow columns 50 of the lower part of the draw tower 36 are improved in their structure, and a support structure 60 is provided at the lowest frame 55 (1) of the draw tower 36.

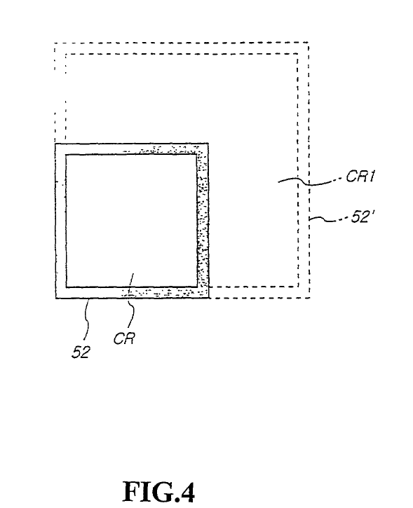

That is, the improved structure of the cantilever beams 52 is realized in the design of the cross-sectional area CR of the cantilever beams 52 of the upper frames, which is designed to be smaller than the cross-sectional area CR1 of a conventional cantilever beam 52′, in order to reduce the weight of the upper part of the draw tower 36, as seen in FIG. 4.

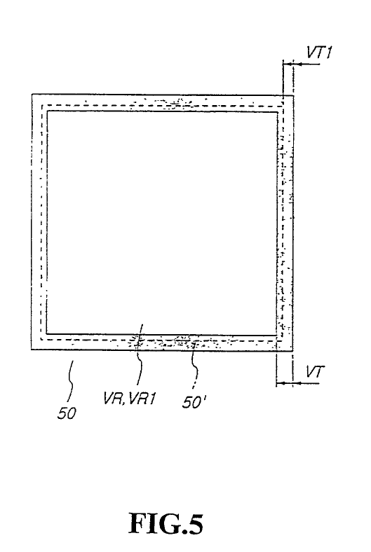

The improved structure of the tower also provides that each of the hollow columns 50 of the lower frames 55 (2), 55 (3), etc. is designed to have the same cross-sectional area VR as VR1 of a conventional hollow column 50′, while having a wall thickness VT thicker than VT1 of the conventional column 50′, thus maintaining sufficient strength, as seen in FIG. 5.

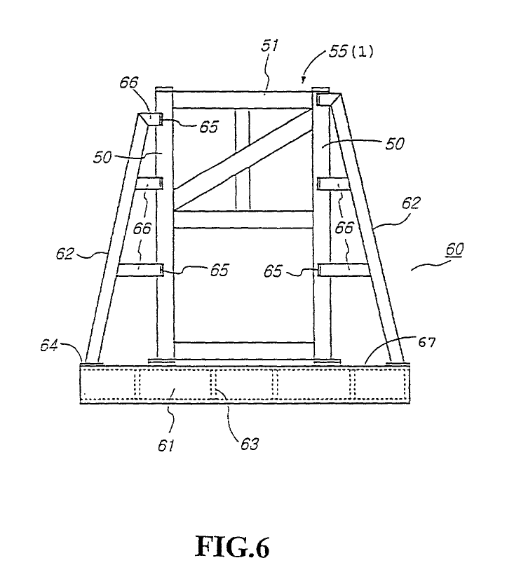

As seen in FIG. 6, the support structure 60 is provided at the lowest frame 55 (1) of the draw tower 36, thus increasing the strength of the draw tower 36, and keeping the draw tower 36 more stable. This support structure 60 includes a base 61 stably supporting the bottom of the lowest frame 55 (1), and a plurality of inclined beams 62 each supporting a column 50 at each corner of the lowest frame 55 (1).

The base 61 is preferably square in shape, and has a sectional area larger than that of the lowest frame 55 (1). This base 61 consists of a horizontal support panel 67 for seating the lowest frame 55 (1) thereon, and a plurality of reinforcing rims 63 provided under the horizontal support panel 67 for maintaining a desired strength of the panel.

The inclined beams 62 each consist of a support plate 64, and a plurality of arms 66 attached to the columns 50 to stabilize the columns 50. The support plate 64 is provided under the lower end of each inclined beam 62 and connected to the base 61, in order to support the inclined beam 62. The arms 66 extend from the inclined beam 62, and each have a finger 65 perpendicularly fixed to the upper part, middle part or lower part of the column 50.

Preferably, the inclined beams 62 provided at four corners of the lowest frame 55 (1) have different lengths, and the fingers are installed at different positions.

According to this invention, the cantilever beam 52 of an upper frame 55 (n) is designed to have a smaller cross-sectional area CR, thus reducing the weight of the upper part of the draw tower 36. Consequently, the entire weight of the draw tower 36 is reduced.

The draw tower 36 of this invention is advantageous in that the inertial effect of the upper part of the draw tower 36 relative to the lower part is reduced, so the natural frequency of the draw tower 36 is increased and the amount of vibration is reduced. Each hollow column 50 of the lower frames 55 (1), 55 (2), etc. is designed to have an increased thickness VT without changing its cross-sectional area VR, thus increasing the weight at the lower portion of the draw tower 36. However, only the lower part of the draw tower 36 is increased in weight, so the draw tower 36 can be stably supported.

As described above, the hollow column 50 of the lower frames 55 (1), 55 (2), etc. has increased thickness VT, so the strength of the lower part 55 is increased. That is, both the load bearing strength of the upper part and the bending strength of the lower part are increased, thus maintaining the draw tower 36 more stably. By increasing both the weight and the strength of the lower part of the draw tower 36, the function of absorbing vibration is increased, thus easily and effectively absorbing the vibration generated during production of optical fibers, and suppressing the vibration of the draw tower 36.

Furthermore, the base 61 of the support structure 60 stably supports the bottom of the lowest frame 55 (1), thus increasing the stability of the draw tower 36. In addition, each of the inclined beams 62 included in the support structure 60 holds the column 50 at each corner of the lowest frame 55 (1), thus preventing the draw tower 36 from being vibrated as well as increasing its strength, thereby supporting the draw tower more stably.

According to the present invention, vibration generated during production of the optical fibers is prevented, and the strength of the draw tower 36 is increased, so that high quality optical fibers are easily produced. It is thus possible to obtain high quality optical fibers, in addition to accomplishing high productivity while producing such optical fibers.

As described above, the present invention provides a draw tower for optical fiber producing systems, which is structurally improved to have sufficient strength, and to reduce vibration frequency thereof, thus having desired stability, without changing the overall cross-sectional area of the draw tower when using a dual-type system for producing optical fibers.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A draw tower for optical fiber producing systems, the draw tower supporting a preform feed unit, a furnace, a spinning nozzle, a diameter gauge, and a coating unit thereon, the draw tower comprising:
a plurality of vertical frames assembled in stacked relation, each of said frames consisting of a column vertically erected at each corner to form a square structure, a plurality of horizontal beams horizontally extending between upper ends and lower ends of the columns, and a cantilever beam diagonally connected between each of said columns;
the cantilever beam of at least one upper frame of said plurality of frames has a cross-sectional area smaller than that of a cantilever beam of a lower frame of said plurality of frames, thus reducing weight of an upper part of said draw tower; and
the columns of at least one lower frame of said plurality of frames each having walls of increased thickness with respect to the columns of the upper part of the draw tower, thus reinforcing a lower part of the draw tower in addition to preventing vibration of the draw tower wherein a support structure is provided at a lowest-most frame of the draw tower for additionally supporting the lower part of the draw tower.

2. The draw tower according to claim 1, wherein said columns, said horizontal beams, and cantilever beams are hollow.

3. The draw tower according to claim 1, wherein said support structure comprises a base for supporting a bottom portion of said lowest-most frame, said base including:
a horizontal support panel for seating the lowest-most frame thereon; and
an inclined beam supporting the column at each corner of said lowest-most frame.

4. The draw tower according to claim 3, wherein a plurality of reinforcing rims are provided under the horizontal support panel for maintaining a desired strength of said panel.

5. The draw tower according to claim 3, further comprising a support plate provided under a lower end of said inclined beam for supporting the inclined beam, and a plurality of arms extending from the inclined beam, each having a finger perpendicularly mounted to one of an upper part, a middle part and a lower part of said vertical column.

6. The draw tower according to claim 5, wherein an inclined beam is provided at each of four corners of said lowest-most frame and have different lengths, with the fingers being installed at different positions.

7. A draw tower for optical fiber producing systems, the draw tower having a plurality of frame structures, the frame structures having a substantially cubic shape including at least one cantilever beam between columns of the frame structure, an uppermost frame structure having at least one cantilever beam with a cross-sectional area smaller than a cross-sectional area of cantilever beams of a bottommost frame structure, and columns of the bottommost frame structure being thicker than columns of the uppermost frame structure.
